(19) United States
(12) Patent Application Publication
(10) Pub. No.: US 2025/0338785 A1
(43) Pub. Date: Nov. 6, 2025

(54) SOIL TREATMENT APPARATUS

(71) Applicant: NOVOKRAFT AG, Riehen (CH)

(72) Inventors: Eric Hardman, Riehen (CH); Rob Jansen, Bergeijk (NL)

(21) Appl. No.: 19/269,653

(22) Filed: Jul. 15, 2025

Related U.S. Application Data
(63) Continuation of application No. PCT/EP2024/050422, filed on Jan. 10, 2024.

(30) Foreign Application Priority Data
Jan. 16, 2023 (DE) 10 2023 100 886.2

(51) Int. Cl. A01B 45/02

(52) U.S. Cl. CPC A01B 45/023

(57) ABSTRACT

A soil treatment apparatus for loosening soil, in particular along a processing direction, in particular for soils with lawn growth, includes a support device and a holding device which is preferably movably held on the support device and on which a plurality of injection elements are held, a lifting device by means of which the injection elements are able to be inserted into and withdrawn from the soil, and a fluid supply device which is fluidically connected, directly or indirectly, to the injection elements for supplying fluid. A respective injection element is held on the holding device and able to be inserted into and withdrawn from the soil individually and/or separately and/or independently of the other injection elements.

### CROSS-REFERENCE TO RELATED APPLICATIONS

This application is a continuation application of international application number PCT/EP2024/050422, filed on Jan. 10, 2024, and claims the benefit of German application number 10 2023 100 886.2, filed on Jan. 16, 2023, which are incorporated herein by reference in their entireties and for all purposes.

### FIELD

The present disclosure relates to a soil treatment apparatus for loosening soil, in particular along a processing direction.

In particular, the present disclosure relates to a soil treatment apparatus for loosening soil, especially along a processing direction in the case of soil with lawn growth.

### BACKGROUND

A generic soil treatment apparatus is described, for example, in DE 10 2018 122 086 A1 and is used to manage soil, for example using needle-shaped injection elements to inject a fluid into the soil. Under the action of the fluid, in particular compressed gas or compressed gas mixture, especially compressed air (in this case the term aeration is used), loosening and thus better ventilation and dewatering of the soil is achieved. Air and water can penetrate the soil better and the drainage effect is improved. In soils with grass growth, for example in sports or leisure facilities, the root system can spread better in the earth to promote growth.

Further soil treatment apparatus for fluid injection and in particular for aeration are described in DE 10 2016 105 248 A1, DE 10 2015 115 991 A1 and DE 10 2016 105 253 A1.

Such soil treatment apparatus generally comprises a plurality of said needle-shaped injection elements for injecting a fluid into the soil. These injection elements are lowered until they engage in the soil. The fluid is then injected via the injection elements for soil loosening, after which the injection elements can be pulled out of the soil again. In this process, the injection elements are lowered and raised together as a single unit. As a rule, irregularities in the soil conditions are not taken into account and/or targeted soil loosening—for example, omitting defined areas—cannot be carried out without having to change the direction of movement of the soil treatment apparatus.

### SUMMARY

An object underlying the present disclosure is to provide an improved soil treatment apparatus of the type mentioned above, which in particular allows more flexible and/or versatile use for loosening soils.

In an aspect of the present disclosure, a soil treatment apparatus for loosening the soil is provided, in particular along a processing direction, in particular for soils with lawn growth.

According to this, a soil treatment apparatus for loosening the soil, in particular for soils with lawn growth, is provided. The soil treatment apparatus comprises a supporting device and a holding device that is preferably movably held on the supporting device, on which holding device a plurality of injection elements are held. The soil treatment device further comprises a lifting device, by means of which the injection elements can be inserted into the soil and can be withdrawn from the soil, and a fluid supply device, which is fluidically connected, directly or indirectly, to the injection elements for supplying fluid. A respective injection element is held on the holding device and can be inserted into the ground and withdrawn therefrom individually and/or independently of the other injection elements.

### BRIEF DESCRIPTION OF THE DRAWINGS

The foregoing summary and the following description may be better understood in conjunction with the drawing figures, of which:

FIG. 1 is a perspective view of a soil treatment apparatus in accordance with an exemplary embodiment of the present disclosure with a user;

FIG. 2 is another perspective view of the soil treatment apparatus of FIG. 1;

FIG. 3 is a plan view of the soil treatment apparatus from FIG. 1;

FIG. 4 is a perspective view of a pre-mounted assembly of the soil treatment apparatus of FIG. 1 with an injection element;

FIG. 5 is a detailed view A of FIG. 4;

FIG. 6 is a detailed view B of FIG. 2;

FIG. 7 is a side view of the soil treatment apparatus of FIG. 1 in a soil treatment position and/or in a pushed-together state;

FIG. 8 is a side view of the soil treatment apparatus of FIG. 1 in a transport position and/or in a pushed-together state;

FIG. 9 is a side view of the soil treatment apparatus of FIG. 1 in a soil treatment position and/or in a pulled-out state;

FIG. 10 is a perspective view of a soil treatment apparatus in accordance with a further exemplary embodiment of the present disclosure;

FIG. 11 is a side view of the soil treatment apparatus of FIG. 10 in a soil treatment position and/or in a pushed-together state;

FIG. 12 is a plan view of the soil treatment apparatus of FIG. 10;

FIG. 13 is a side view of a soil treatment apparatus in accordance with a further exemplary embodiment of the present disclosure in a transport position and/or in a pushed-together state; and

FIG. 14 is a side view of a soil treatment apparatus in accordance with a further exemplary embodiment of the present disclosure in a transport position and/or in a pushed-together state.

### DETAILED DESCRIPTION

Although the present disclosure is illustrated and described herein with reference to specific embodiments, the present disclosure is not intended to be limited to the details shown. Rather, various modifications may be made in the details within the scope and range of equivalents and without departing from the present disclosure.

The present disclosure relates to a soil treatment apparatus for loosening soil, in particular along a processing direction, in particular for soils with lawn growth, said apparatus comprising: a support device and a holding device which is preferably movably held thereon and on which a plurality of injection elements are held, a lifting device by means of which the injection elements are able to be inserted into and withdrawn from the soil, and a fluid supply device which is fluidically connected, directly or indirectly, to the injection elements for supplying fluid, wherein a respective injection element is held on the holding device and is able to be inserted into and withdrawn from the soil individually and/or separately and/or independently of the other injection elements.

In particular, this allows a soil treatment apparatus to be provided in which each injection element can be individually and/or independently inserted into and withdrawn from the soil, so that, advantageously, an insertion process and/or a withdrawal process of a respective injection element is not influenced by other injection elements. For example, if an injection element experiences high resistance when inserted into the soil, for example due to a stone or other foreign body, the remaining injection elements of the soil treatment apparatus can function as intended and in particular inject fluid into the soil. Furthermore, for example, only certain injection elements for injecting fluid into the soil can be selectively controlled, whereby an area to be treated by the soil treatment apparatus can advantageously be treated in portions without changing the direction of treatment, and thus flexibly and/or specifically further.

It should be understood that the information on orientation and position relates in particular to the intended use of the soil treatment apparatus, which is or can be moved along a processing direction on the soil surface. For example, a transverse direction can be oriented transversely and in particular perpendicularly to the processing direction. In particular, for the purposes of the present description, it is non-limiting to assume that the soil surface is substantially horizontal and that a contact plane of the soil treatment apparatus is substantially coincident with the plane defined by the soil surface.

It may be provided that a respective injection element is movable and in particular displaceable via the lifting device under the action of the fluid for the respective insertion into the soil and/or the respective withdrawal from the soil.

In particular, it may be provided that, once the injection elements have been inserted into the soil, the fluid can be supplied to the soil via the injection elements, in particular can be injected into the soil.

It may be provided that a respective injection element is held movably and in particular displaceably on the holding device and the lifting device comprises a number of lifting elements corresponding to the injection elements, by means of which the respective injection elements can be inserted into the soil and/or can be withdrawn from the soil, in particular, can be inserted and/or withdrawn singly and/or individually and/or independently of the other injection elements.

In particular, a respective lifting element can be associated with a respective injection element for insertion into the soil and/or withdrawal from the soil of the same. For example, exactly one respective lifting element can be assigned to exactly one respective injection element.

In particular, the lifting elements can be fixed to the holding device.

The lifting device, in particular the lifting elements of the lifting device, can be advantageously fluidically connected directly or indirectly to the fluid supply device.

This can be understood to mean, in particular, that the lifting device, in particular the lifting elements of the lifting device, and the injection elements can be supplied with fluid by a common fluid source. However, it should be understood that various alternative fluid sources can be provided, e.g. a first fluid supply device, which is directly or indirectly in fluid connection with the lifting device, in particular the lifting elements of the lifting device, and a second fluid supply device, which is directly or indirectly in fluid connection with the injection elements.

It may be provided that a respective injection element for the respective insertion into the soil and/or the respective withdrawal from the soil is operatively connected to a respective lifting element of the lifting device.

A respective lifting element of the lifting device can be designed as a fluid-actuated lifting cylinder, in particular a pneumatic cylinder, or can comprise such a cylinder, which is advantageously directly or indirectly in fluid connection with the fluid supply device.

For example, a respective fluid-actuated lifting cylinder can be designed to be single-acting or double-acting.

The double-acting lifting cylinder can accordingly have a fluidic control input for extending and a fluidic control input for retracting. The control inputs can be fluidically connected to a control valve, for example, that is fixed to the holding device and can be assigned to the respective lifting element. In particular, each lifting element can be directly or indirectly in fluid connection with the fluid supply device via a corresponding control valve.

The single-acting lifting cylinder can accordingly have a fluidic control input for extending or retracting and/or further has an elastic counter-element, in particular a counter-spring element, for applying a restoring force, which counter-spring element serves to retract or extend in the opposite direction to the control input.

Alternatively, it may be conceivable that a respective lifting element of the lifting device can be designed as an electrically actuatable lifting cylinder, in particular a lifting actuator, or can comprise such a cylinder.

It may be provided that the soil treatment apparatus comprises at least one control device for controlling and/or regulating an operation and in particular a fluid operation of the soil treatment apparatus.

In addition, it may be provided that the injection elements are controllable jointly and in particular in a clocked manner via the control device and, advantageously, can be applied with fluid in a clocked manner.

It may be provided that the soil treatment apparatus can be controlled and/or regulated in particular in a clocked manner by means of the control device for the purpose of providing, in particular injecting, fluid into the soil via the respective injection elements above their respective reversal points.

In particular, a respective point of reversal can be defined by alternating between inserting into the soil and withdrawal from the soil of a respective injection element.

It is understood that the lifting device, for example the lifting elements of the lifting device, can advantageously be controllable by the control device of the soil treatment apparatus.

It may be provided that the holding device comprises a number of holding parts corresponding to the injection elements, which are fastened to the remaining holding device, so to speak to the rest of the holding device, in particular detachably, and by means of which the respective injection elements are held individually on the holding device.

This may be understood to mean, in particular, that the holding parts are detachable, in particular removable, components that belong to the holding device and/or form part of it.

In particular, a respective holding part can be assigned to a respective injection element. For example, exactly one respective holding device can be assigned to exactly one respective injection element.

In particular, it may be provided that each holding part comprises a first holding part portion and a second holding part portion, which are arranged opposite one another and between which the respective injection element is held transversely and in particular perpendicularly to the processing direction.

It may be provided that the holding parts are attached, in particular detachably, to the rest of the holding device, in particular via a common supporting element, in particular a common positioning rail.

The common supporting element may be comprised by the holding device and/or form part of it.

For example, the common supporting element can extend transversely and, in particular, perpendicularly to the processing direction.

It may be provided that a respective injection element is guided between the holding portions of the respective holding part by means of a guide element when being inserted into the soil and/or when being withdrawn from the soil.

For example, the respective holding part can comprise the guide element and/or form part of it. Alternatively, the guide element can be designed as a separate component in relation to the respective holding part and can be attachable or can be attached to the respective holding part in a rigid or detachable manner.

It may be provided that the fluid supply device comprises a number of fluid containers corresponding to the injection elements, wherein a fluid container is associated with each injection element and is directly or indirectly in fluid connection therewith for supplying fluid, preferably for the clocked aeration of the soil.

It may be provided that the fluid supply device comprises a number of outlet valves corresponding to the injection elements, wherein one outlet valve is associated with each injection element and wherein a fluid passage through the respective injection element is switchable by means of the associated outlet valve for supplying, in particular injecting, fluid into the soil and preferably for the clocked aeration of the soil.

It may be provided that the fluid supply device comprises a drivable delivery unit for fluid, for example an air compressor.

It may be provided that the fluid supply device further comprises at least one storage container for fluid which can be supplied with fluid for intermediate storage and which is directly or indirectly in fluid connection with the injection elements.

It may be provided that the at least one storage container is fixed to the holding device and/or forms part of the holding device.

For example, the at least one storage container can comprise at least one structural element formed as a substantially closed hollow profile or as a pressure vessel or can be in the form of such, which advantageously extends transversely and in particular perpendicularly to the processing direction. This can enable a structurally simple configuration of the storage container. The holding device can be given the required rigidity by means of the at least one storage container. An interior of the at least one storage container can temporarily store the fluid, in particular compressed air, for injection.

For example, the said common supporting element, in particular the said common positioning rail, can be directly or indirectly attached to the storage container.

It may be provided that the at least one storage container has a round and preferably circular cross section.

The at least one storage container is advantageously made of metal.

Advantageously, the storage container can be in fluid connection with the respective injection elements via the respective fluid containers and/or via the respective outlet valves.

It may be provided that the fluid container and the associated injection element are held as a coherent assembly on the holding device and that the assembly is movable and in particular displaceable, in particular during an insertion and/or a withdrawal of the associated injection element into and out of the soil.

Advantageously, a respective fluid container and the associated injection element can form a pre-mountable or pre-mounted assembly, which is held on the holding device and is movable and in particular displaceable with respect to the holding device, in particular during an insertion and/or a withdrawal of the associated injection element into and out of the soil. This can, for example, simplify the installation of the soil treatment apparatus.

The coherent assembly or the pre-mountable or pre-mounted assembly can, in particular, be held in a detachable manner on the holding device. This can, for example, simplify the repair of the soil treatment apparatus and/or the replacement of the said assemblies, e.g. for maintenance purposes.

It may be provided that a respective fluid container is preferably rigidly connected to a respective outlet valve and the injection element associated with it, and that the fluid container and the outlet valve can be moved together with the injection element, and in particular can be displaced.

For example, a respective fluid container can be connected to the injection element associated with it via a rigidly designed fluid line. This can save on hose lines, for example, and/or a separate holder for the respective fluid container can be omitted.

In particular, the respective outlet valve can be arranged fluidically between the respective fluid container and a fluid outlet of the respective injection element.

Advantageously, the respective outlet valve can be arranged adjacent to a fluid connection point between the respective fluid container and the relevant injection element and in particular downstream with respect to the fluid flow from the fluid container.

It may be provided that the said coherent assembly or the said pre-mountable or pre-mounted assembly further comprises the respective outlet valve, which is associated with the respective injection element of the assembly.

It may be provided that the holding device comprises a number of deep-setting devices corresponding to the injection elements, by means of which the depth of insertion of the respective injection elements into the soil can be set singly and/or individually.

In particular, a respective deep-setting device can be associated with a respective injection element. For example, exactly one respective deep-setting device can be associated with exactly one respective injection element.

The insertion depth can, for example, be advantageously set and/or adjusted in a range from greater than or equal to 5 cm and less than or equal to 30 cm, in particular from greater than or equal to 6 cm and less than or equal to 26 cm, advantageously from greater than or equal to 7 cm and less than or equal to 22 cm, for example from greater than or equal to 8 cm and less than or equal to 20 cm.

The insertion depth can be set and/or adjusted in particular incrementally via the holding device. For example, a respective deep-setting device can be engaged in a force locking and/or positive locking manner with the holding device and in particular the holding part of the holding device that is associated with the respective injection element, for the purpose of setting the insertion depth. In particular, this may be done at discrete points on the holding device and in particular on the holding part concerned.

A number of display devices corresponding to the injection elements can be provided on the holding device, wherein the insertion depth of a respective injection element can be displayed by means of a respective display device.

For example, a respective display device can cover a range from greater than or equal to 5 cm and less than or equal to 30 cm, in particular from greater than or equal to 6 cm and less than or equal to 26 cm, advantageously from greater than or equal to 7 cm and less than or equal to 22 cm, for example from greater than or equal to 8 cm and less than or equal to 20 cm.

For example, a respective display device can display several insertion depth positions using discrete display locations. For example, these display locations may correspond to the said discrete locations of the holding device and in particular the holding part concerned. The respective display locations can, for example, be arranged in 5 mm, 10 mm or 20 mm intervals.

The insertion depth, for example, can be set and/or adjusted without tools and/or manually. For example, a respective deep-setting device can be engaged with the holding device and in particular the holding part of the holding device, which is associated with the respective injection element, for setting the insertion depth without tools and/or manually.

It may be provided that the holding device comprises a number of reset elements corresponding to the injection elements, in particular elastically designed reset elements, by means of which a reset force can be exerted on the respective injection elements, directed away from the soil.

In particular, a respective reset element can be associated with a respective injection element. For example, exactly one respective reset element can be associated with exactly one respective injection element.

Advantageously, a respective reset element can be designed as a spring element, in particular a mechanical spring element, or can comprise such an element.

Alternatively, it may be conceivable that a respective reset element is designed as a spring element, in particular a gas spring element, for example a gas pressure spring element, or comprises such an element.

For example, a respective reset element can be effective to enlarge an injection area of the respective injection element in the soil. In this case, the respective reset element can cause the respective injection element to be reset along the direction of movement and in particular the direction of displacement of the respective injection element for a certain distance when and/or after reaching the respective reversal point under the influence of the said reset force. The determined distance can, for example, be greater than or equal to 3 mm and less than or equal to 30 mm, in particular greater than or equal to 4 mm and less than or equal to 20 mm, advantageously greater than or equal to 5 mm and less than or equal to 15 mm. This means that a free space can be realized below a fluid outlet of a respective injection element for the injection of fluid. It may be provided that fluid can only be injected into the soil when a certain distance has been reached. In particular, this can result in better fluid distribution in the soil.

Furthermore, a respective reset element can advantageously be used to damp a movement, in particular a downward movement, of a respective injection element towards the soil.

It may be provided that each injection element comprises a stop element which, when the injection element is inserted into and/or withdrawn from the soil, can be operatively connected to the associated deep-setting device and/or to the associated reset element in order to limit the insertion depth of the injection element into the soil and/or to move the injection element in a direction oriented away from the soil.

The stop element can be formed on an outer circumferential surface of the respective injection element, for example, or be mountable on it. For example, it may be conceivable that a thread is formed on the circumferential surface of the respective injection element, to which a stop element designed as a nut or a union nut, for example, can be mounted. For example, it may be conceivable that a projection is formed on the circumferential surface of the respective injection element, which forms the stop element. It should be understood that the above examples are intended as illustrations only and are not exhaustive.

It may be provided that a respective deep-setting device comprises a counter-stop element, which interacts with the stop element of the injection element concerned and which can be releasably fixed to the holding device along a direction of movement and in particular along the direction of displacement of the injection element concerned, for setting the insertion depth.

For example, it may be provided that a respective injection element is also guided by means of the respective counter-stop element. For example, a guide passage can be formed in the counter-stop element, through which the respective injection element extends in the assembled state and is thus guided along the direction of movement and in particular the direction of displacement.

For example, it may be provided that a respective counter-stop element forms the said guide element.

The counter-stop element can be detachably attached or attached to the respective holding part in relation to the respective injection element. This may allow for adjustment of the insertion depth, in particular via the detachable fastening.

For example, a respective reset element can be arranged between the stop element of the injection element concerned and the associated deep-setting device and, in particular, the counter-stop element of the associated deep-setting device.

A respective reset element can thus be supported on the stop element of the injection element concerned and the associated deep-setting device and, in particular, the counter-stop element of the associated deep-setting device.

This can enable damping between the stop element of the respective injection element and the associated deep-setting device and in particular the counter-stop element of the associated deep-setting device, in particular when the respective injection element is being inserted into the soil.

It may be provided that each injection element is individually held on the holding device and that a holding position of each injection element can be adjusted on the holding device.

In particular, the holding position of each injection element on the holding device can be adjusted transversely and in particular perpendicularly to the processing direction.

For example, the holding device can comprise at least one positioning rail, via which the holding position of each injection element can be fixed on the holding device with respect to the direction transverse to and in particular perpendicular to the processing direction, in particular in a force-locking and/or form-locking manner.

For example, it may be provided that a respective holding part can be mounted on the positioning rail and a respective injection element can be fixed in its holding position by means of this.

For example, the positioning rail can form the said common supporting element, via which the holding parts are fastened, in a manner that is detachable, to the rest of the holding device, so to speak to the rest of the holding device.

It may be provided that the supporting device comprises at least a first supporting device portion and a second supporting device portion, wherein the soil treatment apparatus can be caused to move in the processing direction by means of the first supporting device portion and the holding device is held on the second supporting device portion, the first supporting device portion and the second supporting device portion being arranged one behind the other along the processing direction and being movably and, in particular, displaceably connected to one another relative to one another along the processing direction.

The supporting device, in particular the first supporting device portion and the second supporting device portion of the supporting device, is/are, inter alia, the subject matter of the non-pre-published patent application with the title “Soil treatment apparatus” of the same applicant with the same filing date as the present patent application. The supporting device described in the present patent application, in particular the first supporting device portion and the second supporting device portion of the supporting device, is/are substantially configured and function as described in the said non-pre-published other patent application.

In particular, it can be provided that the injection elements are insertable into and withdrawable from the soil by means of the lifting device during a relative movement and in particular a relative displacement of the first supporting device portion and the second supporting device portion to one another or when the soil treatment apparatus is not caused to move.

In particular, it may be provided that the first supporting device portion and the second supporting device portion are at least partially nested within and/or against each other in order to be movably and in particular displaceably connected to one another.

In particular, it may be provided that the first supporting device portion and the second supporting device portion are movable and in particular displaceable relative to each other along the processing direction between a first relative position and a second relative position.

In particular, it may be provided that when the first supporting device portion and the second supporting device portion are in the first relative position, the supporting device has a shortest extent along the processing direction and when the first supporting device portion and the second supporting device portion are in the second relative position, the supporting device has a longest extension along the processing direction.

The soil treatment apparatus may be provided with at least one braking device by means of which the second supporting device portion can be decelerated and/or braked relative to the first supporting device portion, in particular with respect to movement in the processing direction.

The braking device is, inter alia, the subject matter of the above-mentioned non-pre-published patent application entitled “Soil treatment apparatus” by the same applicant with the same filing date as the present patent application. The braking device described in the present patent application is essentially designed and functions as described in the said non-pre-published other patent application.

In particular, it may be provided that at least one supporting element is provided on the second supporting device portion for resting on the soil, via which the soil treatment apparatus and in particular the supporting device of the soil treatment apparatus can be guided and in particular driven over the soil, wherein the at least one braking device for decelerating and/or braking the second supporting device portion can be brought into engagement with the at least one supporting element and/or directly with the ground, wherein in particular the at least one supporting element is formed as a wheel or as a roller.

It may be provided that the soil treatment apparatus comprises at least one return device which is attached to the first supporting device portion and the second supporting device portion and connects the first supporting device portion and the second supporting device portion to one another, wherein the first supporting device portion and the second supporting device portion are movable relative to one another and in particular towards one another by means of the at least one return device, wherein in particular the at least one return device is in direct or indirect fluid connection with the fluid supply device.

The return device is, inter alia, the subject matter of the above-mentioned, non-pre-published patent application entitled “Soil treatment apparatus” by the same applicant with the same filing date as the present patent application. The return device described in the present patent application is essentially designed and functions as described in the said non-pre-published other patent application.

It is understood that the at least one braking device and/or the at least one return device can advantageously be controlled by the control device of the soil treatment apparatus.

It can be provided that the soil treatment apparatus comprises an adjustment device by means of which the holding device can be lifted and lowered relative to the soil. In particular, the adjustment device can be mechanical or electrical. For example, the adjustment device can be in the form of an electrical adjustment unit, in particular an electrical linear actuator. The adjustment device can, for example, serve to adjust a distance of the holding device with respect to the soil and/or can, for example, enable a soil treatment position of the holding device, in which the holding device is lowered, and a transport position of the holding device, in which the holding device is lifted.

It may be provided that the soil treatment apparatus has at least one guide device by means of which the holding device is movably held on the supporting device, in particular the second supporting device portion, and by means of which the holding device can be raised and lowered, in particular by means of the adjusting device and/or the lifting device, for example by means of a further or additional lifting element of the lifting device.

It can be provided that the at least one guide apparatus comprises or forms at least one joint apparatus or at least one linear guide apparatus for translational guidance. The guide device can form a parallelogram guide for raising and lowering.

The soil treatment apparatus may be provided with at least one travel drive, in particular at least one motor, which is arranged on and/or in the supporting device and by means of which the soil treatment apparatus can be caused to move in the processing direction.

It may be provided that at least one supporting element for resting on the soil is provided on the first supporting device portion, via which the soil treatment apparatus and in particular the supporting device of the soil treatment apparatus can be guided and in particular driven over the soil, wherein the at least one supporting element can be driven by means of the at least one drive.

It can be provided that the at least one support element, in particular the front one, is in the form of a steered or unsteered support element.

In addition or as an alternative, the soil treatment apparatus may comprise at least one coupling device which is arranged on and/or in the supporting device for coupling the soil treatment apparatus to a separate drive system, in particular a towing vehicle, and by means of which the soil treatment apparatus can be caused to move in the processing direction, in particular by means of a tractive force exertable by the separate drive system.

It can be provided that the soil treatment apparatus has a steering apparatus via which the processing direction is variable, wherein the steering apparatus is manually actuatable by a user and/or by a separate drive system, in particular a towing vehicle, in particular by means of a pulling movement able to be generated thereby and/or actuatable and in particular controllable automatically by means of a control unit associated with the soil treatment apparatus or comprised by the soil treatment apparatus, preferably self-drivingly and/or self-steeringly controllable.

For example, it can be provided that the steering apparatus comprises a motor, in particular an electric motor, via which the processing direction can be varied.

It can be provided that the at least one travel drive and/or the steering apparatus can advantageously be controllable by the control device of the soil treatment apparatus.

It is understood that the lifting device, in particular the lifting elements of the lifting device, and/or the at least one braking device and/or the at least one return device with corresponding supply lines for fluid are in direct or indirect fluid connection with the fluid supply device, for example in indirect fluid connection via the at least one storage container.

It is also understood that the lifting device, in particular the lifting elements of the lifting device, and/or the at least one braking device and/or the at least one return device are equipped with corresponding valves for controllable actuation, wherein these valves can advantageously be controllable by the control device of the soil treatment apparatus. Preferably, clocked control of the valves is provided in this case.

It should be understood that, although the lifting device, in particular the lifting elements of the lifting device, and/or the at least one braking device and/or the at least one return device are described as fluidically actuatable and/or operable, the lifting device, in particular the lifting elements of the lifting device, and/or the at least one braking device and/or the at least one return device can alternatively be designed mechanically and/or electrically.

When implementing the soil treatment apparatus in practice, it proves to be advantageous if the lifting device, in particular the lifting elements of the lifting device, and/or the at least one braking device and/or the at least one return device are pneumatically designed. In this way, for example, a or the drivable conveying unit for fluid, in particular a or the air compressor, can be used jointly and additional units and/or apparatuses can be avoided. For example, an in particular separate hydraulic system and/or unit can be dispensed with. However, it should be understood that the lifting device, in particular the lifting elements of the lifting device, and/or the at least one braking device and/or the at least one return device can alternatively be of hydraulic design and the soil treatment apparatus can accordingly have a hydraulic motor for providing hydraulic fluid at least for the lifting device, in particular the lifting elements of the lifting device, and/or the at least one braking device and/or the at least one return device.

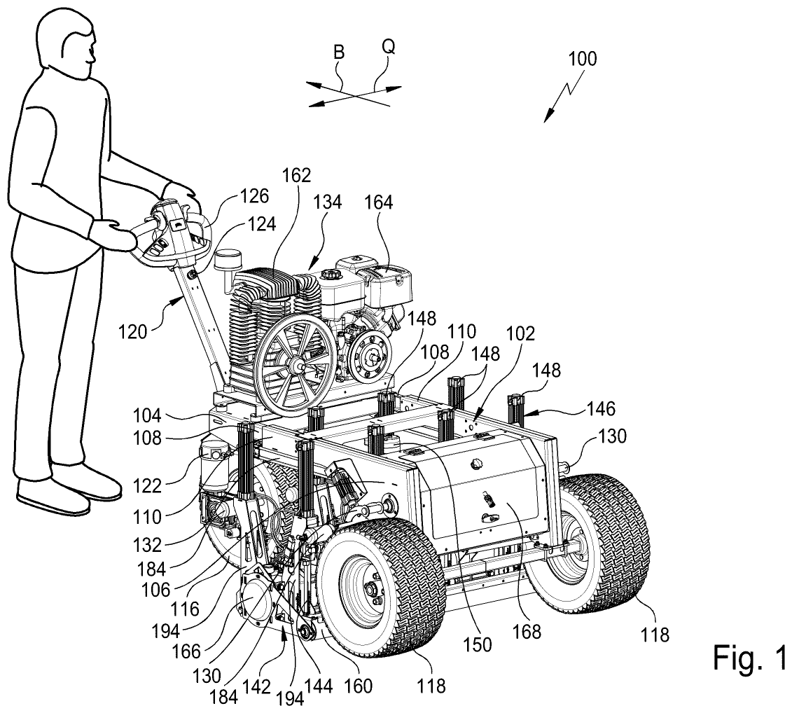

Identical or equally acting features are provided with the same reference numerals in all figures. With reference to FIGS. 1 to 9, there is schematically shown a soil treatment apparatus 100 in accordance with an exemplary embodiment of the present disclosure.

The soil treatment apparatus 100 serves in particular for loosening soil, preferably for loosening soil in the case of soils with grass growth.

With the advantageous soil loosening, improved soil aeration, dewatering and drainage can be achieved. This allows the root system of the grass growth to spread better in the soil to promote growth.

It should be understood that the present disclosure is not limited to being applied to soil of the type described; this merely serves to better explain the present disclosure.

The soil treatment apparatus 100 serves in particular to loosen the soil along a processing direction B.

This is to be understood in particular to mean that the soil treatment apparatus 100 is movable on a soil surface, in particular in the processing direction B.

In the processing direction B, the soil treatment apparatus 100 can be moved, for example, in a straight line.

It should be understood that the processing direction B refers to an intended use of the soil treatment apparatus 100. The processing direction B corresponds to a main direction of movement during the intended use.

A transverse direction Q of the soil treatment apparatus 100 is oriented transversely and in particular perpendicularly to the processing direction B.

The soil treatment apparatus 100 includes a supporting device 102, which for example includes or is formed as a frame made of interconnected beams.

The supporting device 102 comprises at least a first supporting device portion 104 and a second supporting device portion 106.

The soil treatment apparatus 100 can be made to move in a processing direction B via the first supporting device portion 104.

The supporting device 102, in particular the first supporting device portion 104 and the second supporting device portion 106 of the supporting device 102, is/are, inter alia, the subject of the non-pre-published patent application with the title “Soil treatment apparatus” of the same applicant with the same filing date as the present patent application. The supporting device 102 described in the present patent application, in particular the first supporting device portion 104 and the second supporting device portion 106 of the supporting device 102, is/are essentially designed and function as described in the said non-pre-published other patent application.

The first and the second supporting device portion 104, 106 are arranged one behind the other in the processing direction B, with the first supporting device portion 104 leading.

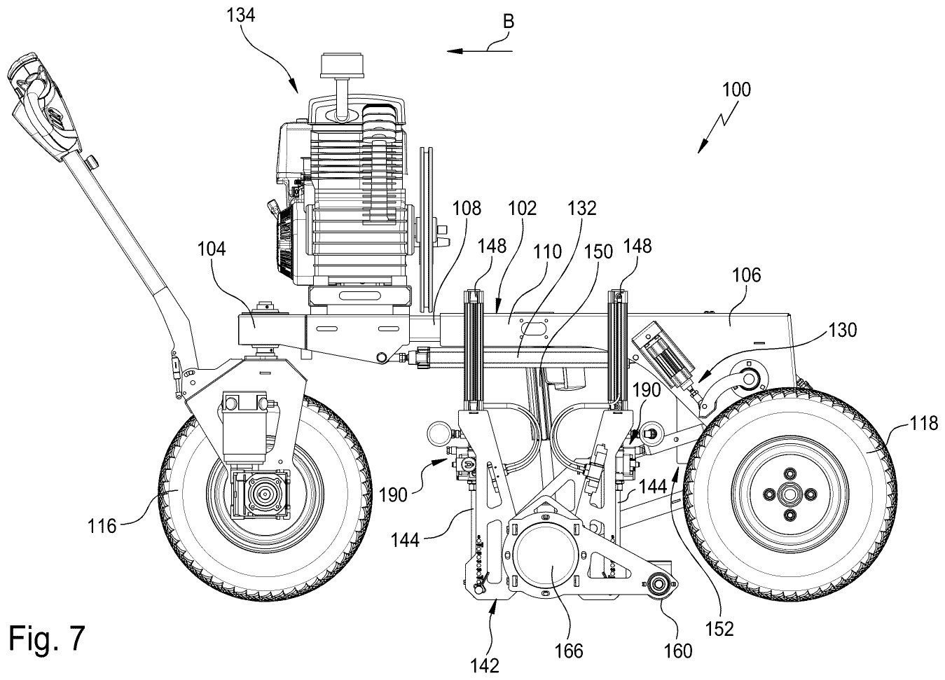

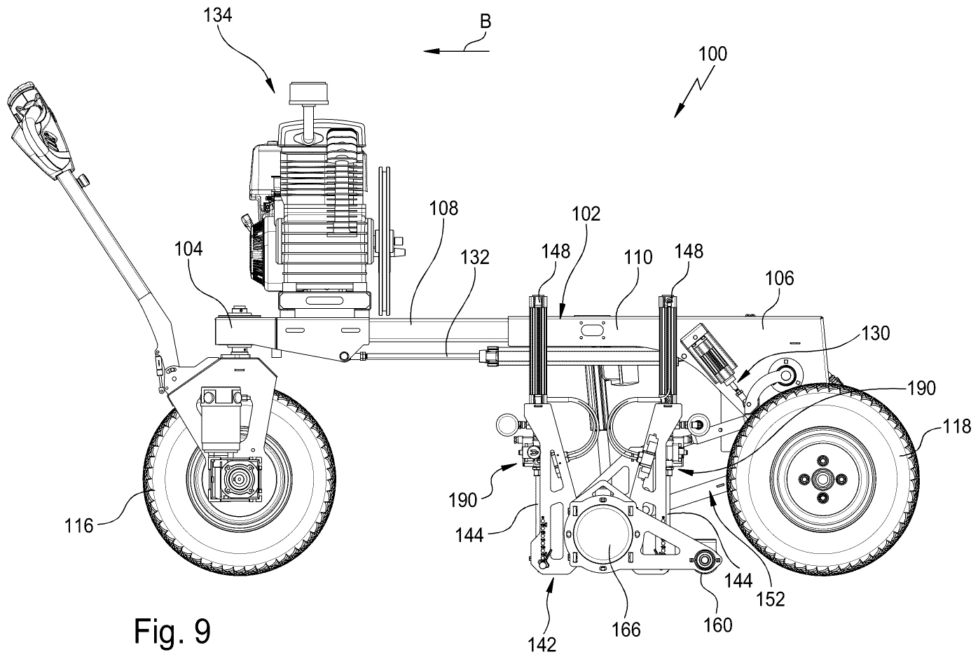

The first and the second supporting device portion 104, 106 are interconnected so as to be movable and in particular slidable relative to one another in the processing direction B (cf. FIGS. 7 and 9).

Further, the soil treatment apparatus 100 comprises a fluid supply device 134, a holding device 142, a plurality of injection elements 144 and a lifting device 146.

The injection elements 144 serve in particular to inject a fluid into the soil. Under the effect of the fluid, in particular a compressed gas or compressed gas mixture, especially compressed air, loosening and thus better ventilation and dewatering of the soil can be realized.

As can be seen in particular in FIGS. 1 to 3, the fluid supply device 134 comprises a drivable delivery unit for fluid, in particular an air compressor 162, and an internal combustion engine 164, wherein the air compressor 162 is drivable by means of the internal combustion engine 164 and is driven in operation. Instead of the internal combustion engine 164, a different type of engine could be used.

It should be understood that a torque transmission element between the air compressor 162 and the internal combustion engine 164 has been omitted to improve the clarity of the figures. The torque transmission element can be in the form of a belt or a chain, for example.

The fluid supply device 134 is in fluid connection with the injection elements 144 for supplying fluid directly or indirectly.

The holding device 142 is held on the supporting device 102 in particular movably.

In particular, the holding device 142 is held on the second supporting device portion 106.

In the present case, the injection elements 144 are held on the holding device 142. In other words, a respective injection element 144 is held on the holding device 142.

The injection elements 144 can be inserted into and withdrawn from the soil via a lifting device 146. In other words, a respective injection element 144 can be inserted into and withdrawn from the soil via the lifting device 146.

In particular, the injection elements 144 are insertable into and withdrawable from the soil by means of the lifting device 146 during a relative movement and in particular a relative displacement of the first supporting device portion 104 and the second supporting device portion 106 to one another or when the soil treatment apparatus 100 is not caused to move.

This can ensure, for example, that damage to the injection elements 144 when inserted into the soil, when being inserted and/or when being withdrawn, for example due to a shear force caused by movement, can be reliably avoided.

A respective injection element 144 can be inserted into and withdrawn from the soil individually and/or separately and/or independently of the respective other injection elements 144 by means of the lifting device 146.

In particular, this can ensure that an insertion process and/or an withdrawal process of a respective injection element 144 is not influenced by other injection elements 144. For example, if an injection element 144 experiences a high resistance when inserted into the soil, for example due to a stone or other such foreign object, the remaining injection elements 144 of the soil treatment apparatus 100 may function as intended and in particular inject fluid into the soil.

In addition, only certain injection elements 144 for injecting fluid into the soil can be selectively controllable, for example, whereby advantageously a processing area of the soil treatment apparatus 100 can be further processed section by section and thus flexibly without changing the processing direction B.

The injection elements 144 are movably held on the holding device 142.

In particular, the injection elements 144 are held on the holding device 142 so as to be movable in a direction relative to the processing direction B and the transverse direction, for example vertically.

A respective injection element 144 is movable and in particular displaceable via the lifting device 146 under the action of the fluid. This is used for insertion into the floor and/or removal from the soil.

In particular, this can be understood to mean that a respective injection element 144 is held movably and in particular displaceably on the holding device 142.

The lifting device 146 comprises a number of lifting elements 148 corresponding to the injection elements 144 held so as to be movable relative to the holding device 142.

The lifting elements 148 are fixed to the holding device 142.

The respective injection elements 144 can be inserted into and withdrawn from the soil via the lifting elements 148.

When a respective injection element 144 is inserted into the soil, the fluid can be supplied to the soil via the injection element 144, in particular can be injected, in particular for loosening the soil.

In particular, each injection element 144 is associated with a lifting element 148 on which the injection element 144 is movably held.

The associated injection element 144 can be inserted into and withdrawn from the soil via the corresponding lifting element 148.

As can be seen in particular in FIGS. 1 to 9, in the present case precisely one respective lifting element 148 is assigned to precisely one respective injection element 144.

In particular, the respective injection elements 144 can be inserted into and withdrawn from the soil individually and/or separately and/or independently of the respective other injection elements 144 via the respective associated lifting elements 148.

For this purpose, the respective lifting elements 148 are operatively connected to the respective injection elements 144 for insertion into and withdrawal from the soil. In other words, a respective injection element 144 is operatively connected to a respective lifting element 148 of the lifting device 146 for respective insertion into the ground and/or respective withdrawal from the ground.

A respective lifting element 148 of the lifting device 146 is designed in the present case as a fluidically actuated lifting cylinder, in particular a pneumatic cylinder.

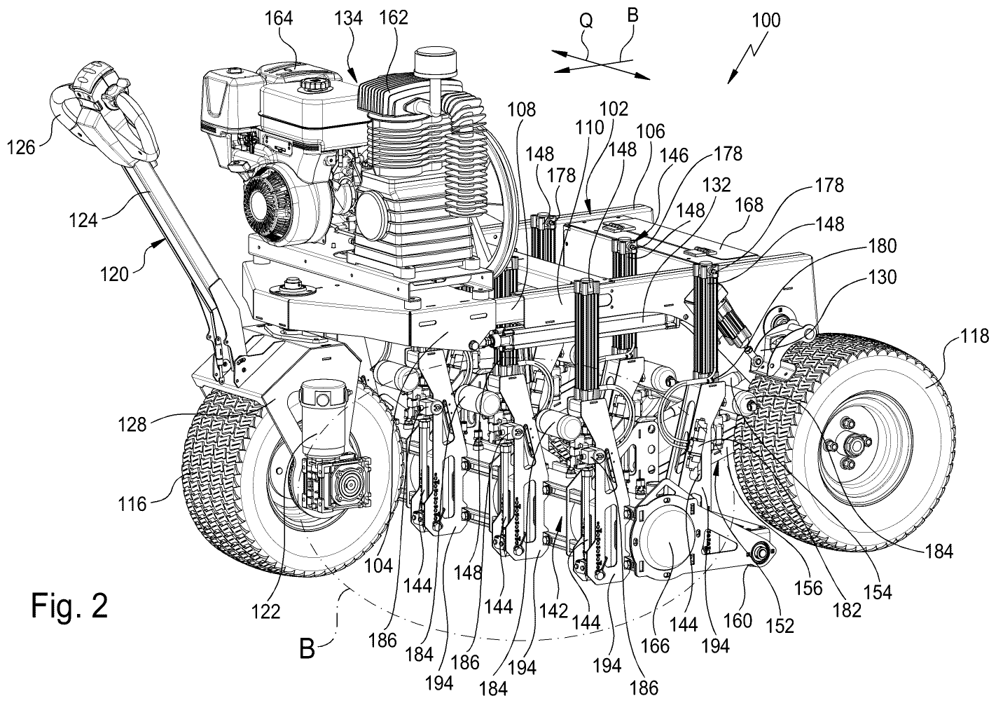

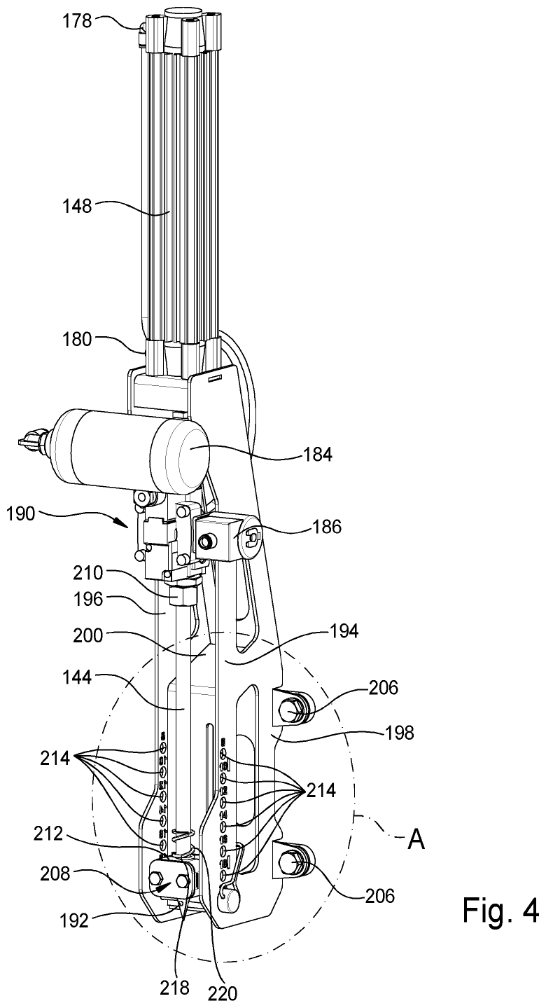

In particular, a respective lifting element 148 is designed to be double-acting and accordingly has a first fluidic control input 178 for extending and a second fluidic control input 180 for retracting (see in particular FIGS. 2 and 4).

The first and second control inputs 178, 180 are fluidically connected to a control valve 182 fixed to the holding device 142, which is assigned to the respective lifting element 148.

In particular, this can be understood to mean that each lifting element 148 is assigned such a control valve 182 and is fluidically connected to it.

Each lifting element 148 of the lifting device 146 is in direct or indirect fluid connection with the fluid provision device 134.

In particular, each lifting element 148 is in direct or indirect fluid connection with the fluid supply device 134 via a respective control valve 182.

In particular, this can be understood to mean that the lifting device 146, in particular the lifting elements 148 of the lifting device 146, and the injection elements 144 can be supplied or are supplied with fluid by a common fluid source, in this case the fluid supply device 134.

The fluid supply device 134 further comprises a plurality of fluid containers 184 corresponding to the injection elements 144 and a plurality of outlet valves 186 corresponding to the injection elements 144.

In each case, a fluid container 184 is associated with an injection element 144 and is in direct or indirect fluid connection with the latter for the provision of fluid, preferably for the pulsed aeration of the soil.

Each fluid container 184 is in direct or indirect fluid connection with the fluid supply device 134.

A respective fluid container 184 can temporarily store the fluid, in particular compressed air, for injection by the respective injection element 144.

In each case, an outlet valve 186 is assigned to an injection element 144.

A fluid passage through the relevant injection element 144 can be switched by means of the associated outlet valve 186 for providing, in particular injecting, fluid into the base and preferably for the timed aeration of the base.

This can be the fluid from the respective assigned fluid container 184.

Furthermore, the fluid supply device 134 comprises a storage container 166 for fluid, which can be supplied with fluid for intermediate storage by means of the air compressor 162.

The storage container 166 is in fluid connection with the injection elements 144 via the respective fluid containers 184.

The storage container 166 is also in fluid connection with the lifting elements 148 via the respective control valves 182.

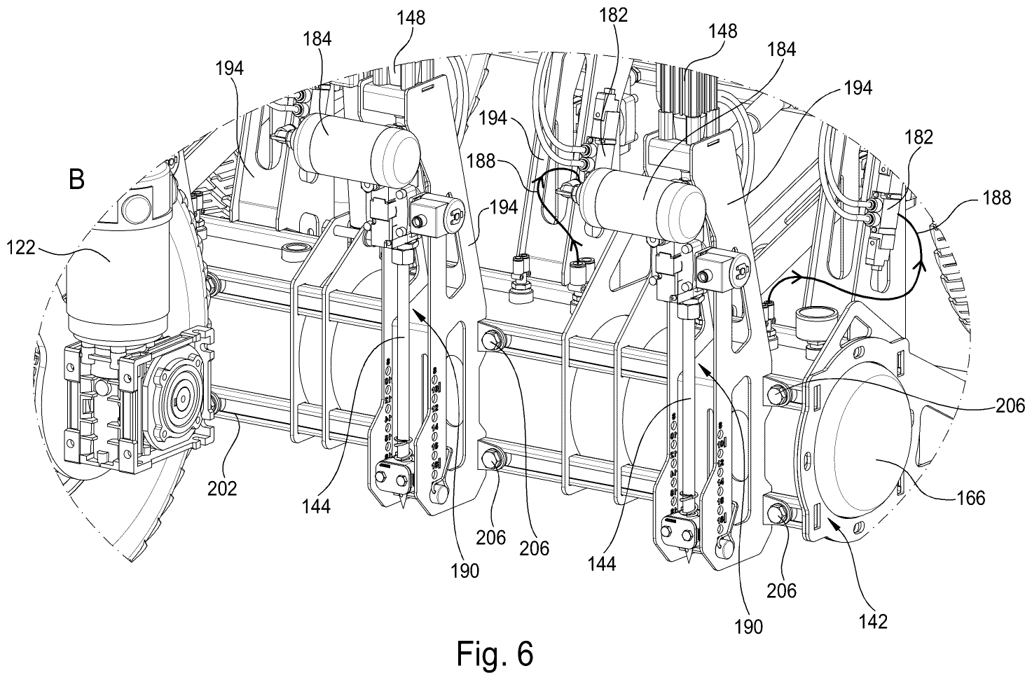

As an example, the two aforementioned compounds are shown schematically in FIG. 6 using a fluid connection marked with the reference numeral 188. These fluid connections 188 can be realized, for example, by means of a flexible hose 188 in particular. It is understood that the other fluid connections can be realized in the same manner and are not explicitly shown in the figures for reasons of clarity.

The storage container 166 forms part of the holding device 142.

The storage container 166 is designed as a structural element formed as a pressure vessel, which extends transversely and in particular perpendicularly to the processing direction B. The holding device 142 can be given the required rigidity via the storage container 166.

The storage container 166 has a round and preferably circular cross-section. The storage container 166 is advantageously made of metal.

The fluid container 184 and the associated injection element 144 are held as a coherent assembly 190 on the holding device 142.

This assembly 190 can be pre-mounted. To a certain extent, the coherent assembly 190 can be designated as a pre-mountable or pre-mounted assembly.

Here, a respective fluid container 184 is preferably rigidly connected to a respective outlet valve 186 and the injection element 144 associated therewith, such that the fluid container 184 and the outlet valve 186 together with the injection element 144 are movable and in particular displaceable.

In the present case, a respective fluid container 184 is connected to its associated injection element 144 via a rigidly designed fluid conduit. This can save on hose conduits, for example, and/or a separate holder for the respective fluid container 184 can be omitted.

The respective outlet valve 186 is fluidically arranged between the respective fluid container 184 and a fluid outlet 192 of the respective injection element 144.

As can be seen in particular in FIG. 4, the respective outlet valve 186 is arranged adjacent to an in particular fluidic connection point between the respective fluid container 184 and the respective injection element 144 and in particular downstream of the fluid flow with respect to the fluid container 184.

The assembly 190 is movable and in particular displaceable, in particular during insertion and/or withdrawal of the associated injection element 144 into and out of the soil.

In particular, this can be understood to mean that all components belonging to the assembly 190 can be moved together and, in particular, can be displaced.

The coherent assembly 190 or the pre-mountable or pre-mounted assembly 190 can, in particular, be held in a detachable manner on the holding device 142. This can, for example, simplify repair of the soil treatment apparatus 100.

As can be seen in particular in FIGS. 1 to 3, the holding device 142 comprises a number of holding parts 194 corresponding to the injection elements 144.

The holding parts 194 are detachably attached to the remaining holding device 142, as it were to the remaining part of the holding device 142.

A respective coherent assembly 190 and, correspondingly, a respective injection element 144 and a respective lifting element 148 are individually held on the holding device 142 via a respective holding part 142.

A respective holding part 142, a respective coherent assembly 190 and a respective lifting element 148 can be pre-mounted. Therefore, a respective holding part 142, a respective coherent assembly 190 and a respective lifting element 148 can also form a pre-mountable or pre-mounted assembly, which is superordinate with respect to the coherent assembly 190. In a sense, it is a higher-level assembly.

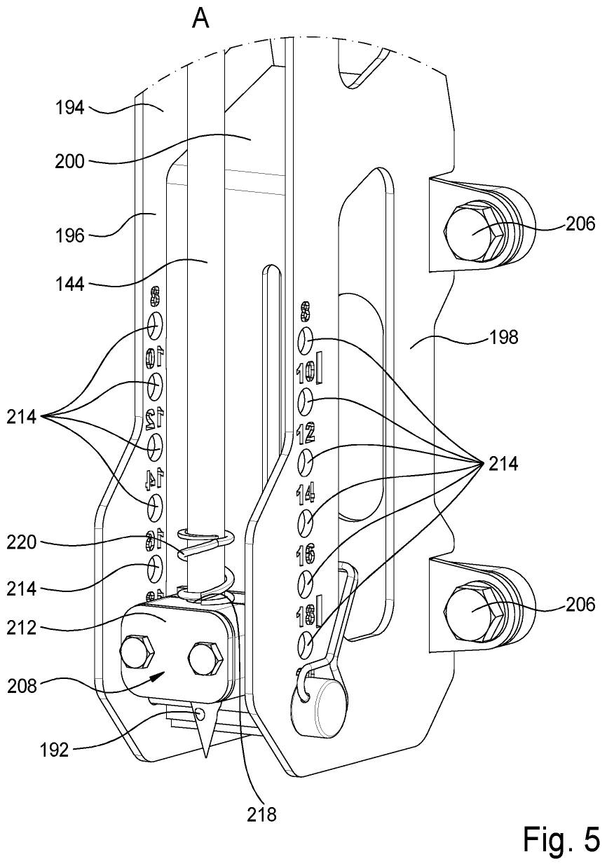

Each holding part 142 comprises a first holding part portion 196 and a second holding part portion 198, which are connected to each other via a central portion 200 (see in particular FIGS. 4 and 5).

The first and second holding part portions 196, 198 are arranged opposite one another, in particular along the transverse direction Q.

Between the first and second retaining portions 196, 198, the respective injection element 144 is held transversely and in particular perpendicularly to the processing direction.

The respective holding parts 194 are mounted on the remaining holding device, so to speak on the remaining part of the holding device, in particular in a detachable manner, via at least one supporting element, the at least one supporting element comprising a first pair of positioning rails 202 and a second pair of positioning rails 204.

The detachable fastening takes place, for example, via a detachable screw connection 206, which is shown as an example in the figures.

The first pair of positioning rails 202 can serve as a common supporting element for the holding parts 194 held on it, and the second pair of positioning rails 204 can serve as a common supporting element for the holding parts 194 held on it.

A respective pair of positioning rails 202, 204 extends transversely and in particular perpendicularly to the processing direction B.

A respective pair of positioning rails 202, 204 is fixed directly to the storage container 166.

The first and second pair of positioning rails 202, 204 are arranged on opposite sides of the storage container 166 with respect to the processing direction B. Here, the first pair of positioning rails 202 is guiding with respect to the processing direction B.

The first and second pair of positioning rails 202, 204 are used to adjust a holding position of each injection element 144 on the holding device 142.

In a sense, a holding position of each injection element 144 on the holding device 142 is adjustable via the respective holding part 194 and the corresponding pair of positioning rails 202, 204.

In particular, the holding position of each injection element 144 on the holding device 142 can be adjusted transversely and in particular perpendicularly to the processing direction B.

As can be seen in the figures, and particularly in FIGS. 4 and 5, the holding device 142 comprises a number of deep-setting devices 208 corresponding to the injection elements 144.

A respective deep-setting device 208 is arranged on the respective holding parts 194.

In particular, a respective deep-setting device 208 is associated with a respective injection element 144.

By means of a respective deep-setting device 208, an insertion depth into the soil of the respective injection elements 144 is individually and/or individually adjustable.

Each injection element 144 comprises a stop element 210, and each deep-setting device 208 comprises a counter-stop element 212, which interacts with the stop element 210 of the relevant injection element 144.

The stop element 210 of each injection element 144 striking against the respective counter-stop element 212 limits the insertion depth of the respective injection element 144.

The stop element 210 is mountable on an outer circumferential surface of the respective injection element 144. In the present case, a thread is formed on the circumferential surface of the respective injection element 144 (not shown in the figures), on which a stop element 210 formed as a nut or union nut can be mounted and is mounted in the present case.

A respective counter-stop element 212 can be releasably fixed to a respective holding part 194 of the holding device 142 along a direction of movement and in particular a direction of displacement of the relevant injection element 144 to adjust the insertion depth.

The detachable fastening takes place here via a positive-locking and/or force-locking connection between a first connecting element, for example a pin, bolt, screw, etc., and at least one recess 214 in the respective holding part 194 (see in particular FIGS. 4 and 5).

The insertion depth can advantageously be set and/or adjusted without tools and/or manually, in particular via the detachable fastening.

In particular, a plurality of recesses 214 are formed in a respective holding part 194 along the direction of movement and, in particular, the direction of displacement of the respective injection element 144, which recesses correspond to an insertion depth of the respective injection element 144.

The respective recesses 214 define discrete positions for setting and/or adjusting the insertion depth.

The insertion depth can be adjusted by the counter-stop element 212 being detachably fastenable and/or securable or fastened and/or fixed to the respective holding part 194, in particular via the said recesses 214.

The insertion depth can be set and/or adjusted within a range of greater than or equal to 8 cm and less than or equal to 20 cm.

In particular, the insertion depth can be incrementally set and/or adjusted via the respective recesses 214.

Furthermore, a number of display devices 216 corresponding to the injection elements is provided on the holding device 142, wherein the insertion depth of a respective injection element 144 can be indicated by means of a respective display device 216.

In the present case, a respective display device 216 is formed as insertion depth markings associated with the recesses 214, which are provided in the respective holding parts 194. It should be understood that this is an exemplary embodiment and that another embodiment may additionally or alternatively be provided, such as an electronic display device 216 for example with a display and/or a corresponding sensor unit.

In the present case, a respective display device 216 comprises a range of greater than or equal to 8 cm and less than or equal to 20 cm.

Here, a respective display device 216 indicates insertion depth positions by means of discrete display locations which correspond to the recesses 214. In the present case, the respective display locations are arranged at 20 mm intervals from one another.

In the embodiment of FIGS. 4 and 5, the counter-stop element 212 is detachably fixed in the lowest recess 214, which is located 20 mm below the 18 cm display location and therefore corresponds to an insertion depth of 20 cm.

In addition to the depth-setting function, a respective counter-stop element 212 is used to guide a respective injection element 144.

As can be seen in particular in FIGS. 4 to 6, a respective injection element 144 is guided between the holding portions 196, 198 of the respective holding part 194 when it is inserted into the soil and/or when it is withdrawn from the soil.

For this purpose, a guide passage 218 is formed in each counter-stop element 212.

The respective injection element 144 extends through this guide passage 218 in the assembled state and is thus guided along the direction of movement and, in particular, the direction of displacement.

In a sense, a respective counter-stop element 212 can form a guide element for an injection element 144.

As can be seen in the figures, the holding device 142 has a number of reset elements 220 corresponding to the injection elements 144.

A respective reset element 220 is associated with a respective injection element.

Each reset element 220 is designed as a spring element, in particular a mechanical spring element; in the present case, by way of example, as a helical spring.

By means of a respective reset element 220, a restoring force can be exerted on the respective injection element 144, which is directed away from the soil.

A respective reset element 220 is arranged between the stop element 210 of the respective injection element 144 and the counter-stop element 212 of the associated deep-setting device 208.

A respective reset element 220 is arranged in particular on the respective counter-stop element 212 of the associated deep-setting device 208 and is supported on it.

A respective reset element 220 serves in particular to enlarge an injection area of the respective injection element 144 in the soil.

Here, the respective reset element 220 can cause the respective injection element 144 to be reset along the direction of movement and, in particular, the direction of displacement of the respective injection element 144 for a certain distance when and/or after reaching a respective reversal point under the action of said reset force. The determined distance can, for example, be greater than or equal to 3 mm and less than or equal to 30 mm, in particular greater than or equal to 4 mm and less than or equal to 20 mm, advantageously greater than or equal to 5 mm and less than or equal to 15 mm.

As a result, a free space for injecting fluid can be realized below the fluid outlet 192 of a respective injection element 144.

Advantageously, the fluid can only be injected into the soil through the relevant injection element 144 once the specified distance has been reached.

Furthermore, a respective reset element 220 advantageously serves to dampen a movement, in particular downward movement, of a respective injection element 144 towards the soil.

In particular, a damping effect can be realized between the stop element 210 of the respective injection element 144 and the associated deep-setting device 208 and in particular the counter-stop element 212 of the associated deep-setting device 208 by means of a respective reset element 220, in particular when the respective injection element 144 is being introduced into the soil.

Furthermore, the soil treatment apparatus 100 has a control device 168 for controlling an or the operation, in particular a fluid operation, of the soil treatment apparatus 100.

In the present case the control device 168 is housed in the end portion of the second supporting device portion 106, thus ensuring that it is safely stored and protected from external influences.

The injection elements 144 can be controlled jointly and/or individually and/or independently of one another via the control device 168 and, in particular, in a clocked manner and, advantageously, fluid can be applied in a clocked manner.

In particular, the respective outlet valves 186 can be controlled for this purpose by means of the control device 168.

It is understood that the respective outlet valves 186 are connected to the control device 168 for signaling purposes.

Furthermore, the lifting elements 148 can be controlled jointly and/or individually and/or independently of one another via the control device 168 and, in particular, in a clocked manner and, advantageously, fluid can be applied in a clocked manner.

In particular, the respective control valves 182 can be controlled for this purpose by means of the control device 168.

It is understood that the respective control valves 182 are connected to the control device 168 by means of signals for this purpose.

In particular, this can be understood to mean that the soil treatment apparatus 100 can be controlled in a clocked manner for providing, in particular injecting, fluid into the soil via the respective injection elements 144 by means of the control device 168.

In particular, the soil treatment apparatus 100 for providing, in particular injecting, fluid into the soil via the respective injection elements 144 above their respective reversal points can be controlled in a clocked manner by means of the control device 168.

A respective reversal point is defined by an alternation between an insertion into the soil and a withdrawal from the soil of a respective injection element 144.

Insertion into the soil and withdrawal from the soil of the respective injection element 144 is dependent on the fluidic control of the lifting elements 148, in particular depending on the pressurization of the respective first and/or second control input 178, 180.

As already described, the first and second supporting device portions 104, 106 are movable relative to one another along the processing direction B and, in particular, are displaceably connected to one another (see FIGS. 7 and 9).

The first supporting device portion 104 and the second supporting device portion 106 are at least partially nested within and/or against one another so as to be movably and in particular displaceably connected to one another.

As can be seen in particular in FIGS. 1 to 3, the first supporting device portion 104 and the second supporting device portion 106 are connected to one another on opposite sides with respect to the transverse direction Q via a respective first guide element 108 and a respective second guide element 110, which each extend in the processing direction B.

Each first guide element 108 is held in and on the respectively assigned second guide element 110 such that it can be displaced, for example by means of a bearing arrangement, in particular a rolling body arrangement or roller bearing arrangement, not shown in the figures.

The first supporting device portion 104 and the second supporting device portion 106 are movable and in particular displaceable relative to each other along the processing direction B via the bearing arrangements 112 between a first relative position (see FIGS. 1 to 3, 7 and 8) and a second relative position (see FIG. 9).

The soil treatment apparatus 100 is in a pushed-together state when the first supporting device portion 104 and the second supporting device portion 106 are in the first relative position.

The soil treatment apparatus 100 is in a pulled-out state when the first supporting device portion 104 and the second supporting device portion 106 are in the second relative position.

A switching process from the first relative position to the second relative position or from the pushed-together state to the pulled-out state can be understood to mean extending and/or pulling apart.

A switching process from the second relative position to the first relative position or from the pulled-out state to the pushed-together state can be understood to mean shortening and/or contracting.

The injection elements 144 can be inserted into the soil and withdrawn therefrom by means of the lifting device 146 and in particular by means of the lifting elements 148 of the lifting device 146, during a relative movement and in particular a relative displacement of the first supporting device portion 104 and the second supporting device portion 106 with respect to one another, or when the soil treatment apparatus 100 is not caused to move.

In particular, the injection elements 144 can be inserted into and withdrawn from the soil by means of the lifting device 146, in particular by means of the lifting elements 148 of the lifting device 146, during extension and/or pulling apart of the supporting device 102.

In a sense, the fluid can be supplied to the soil via the respective injection elements 144, in particular it can be injected when a respective injection element 144 is inserted into the soil while the supporting device 102 is being extended and/or pulled apart.

A support element 116 in the form of a wheel for resting on the soil is provided on the first supporting device portion 104.

In a sense, since the support element 116 in the form of a wheel is provided on the first supporting device portion 104, the support element 116 can be referred to as a front support element 116 and in particular as a front wheel 116.

On the second supporting device portion 106, two further support elements 118, each in the form of a wheel, are provided for resting on the soil, and are spaced apart from one another in the transverse direction Q.

In a sense, since the further support elements 118, each in the form of a wheel, are provided on the second supporting device portion 104, these support elements 118 can be referred to as rear support elements 118 and in particular as rear wheels 118.

The soil treatment apparatus 100 and in particular the supporting device 102 of the soil treatment apparatus 100 is guidable and in particular drivable over the soil via the front wheel 116 and the rear wheels 118.

In this case, the front wheel 116 is fixed to a front end portion of the first supporting device portion 104 with respect to the processing direction B.

In this case, the rear wheels 118 are fixed to a rear end portion of the second supporting device portion 106 with respect to the processing direction B.

The supporting device 102 thus extends with respect to the processing direction B substantially between the front wheel 116 and the rear wheels 118.

In particular, the front wheel 116 is arranged substantially centrally with respect to an extent of the first supporting device portion 104 in the transverse direction Q.

In particular, the rear wheels 118 are arranged laterally and on opposite sides with respect to the extent of the second supporting device portion 106 in the transverse direction Q.

The front wheel 116 is steerable and, for example, directly or indirectly drivable and is arranged on the first supporting device portion 104.

For this purpose, the soil treatment apparatus 100 has a steering apparatus 120 and a travel drive 122.

The processing direction B of the soil treatment apparatus 100 can be varied via the steering apparatus 120.

The steering apparatus 120 can be manually actuated by a user.

The steering apparatus 120 comprises a handle device 124, which in this case is lever-shaped, having a handle head 126, which allows the user to operate, in particular to actuate the steering of, the steering apparatus 120, and a suspension device 128 which is rotatably mounted on the first supporting device portion 104 and on which the front wheel 116 is mounted and via which the front wheel 116 is attached to the first supporting device portion 104.

The suspension device 128 is mounted on the first supporting device portion 104 so as to be rotatable about an axis perpendicular to the processing direction B and the transverse direction Q in order to realize steerability of the soil treatment apparatus 100.

The travel drive 122 is in this case fixed to the suspension device 128 for driving the front wheel 116. The travel drive 122 is in the form of a motor, in particular an electric motor.

The front wheel 116 can be driven by means of the travel drive 122 and in this way the soil treatment apparatus 100 can be caused to move in the processing direction B.

To a certain extent, the entire soil treatment apparatus 100 can be driven by means of the travel drive 122 via the front wheel 116.

In the present case, the rear wheels 118 are non-steerably and non-drivably attached to the second supporting device portion 106. This could nevertheless be provided for.

The soil treatment apparatus 100 further comprises two braking devices 130 and two return devices 132.

The braking devices 130 and the return devices 132 are each directly or indirectly in fluid connection with the fluid provision device 134 and are fluidically actuatable and/or operable.

In particular, the braking devices 130 and the return devices 132 can be controlled by means of the control device 168.

By means of the braking devices 130, the second supporting device portion 106 can be decelerated and/or braked relative to the first supporting device portion 104, in particular with respect to a movement in the processing direction B.

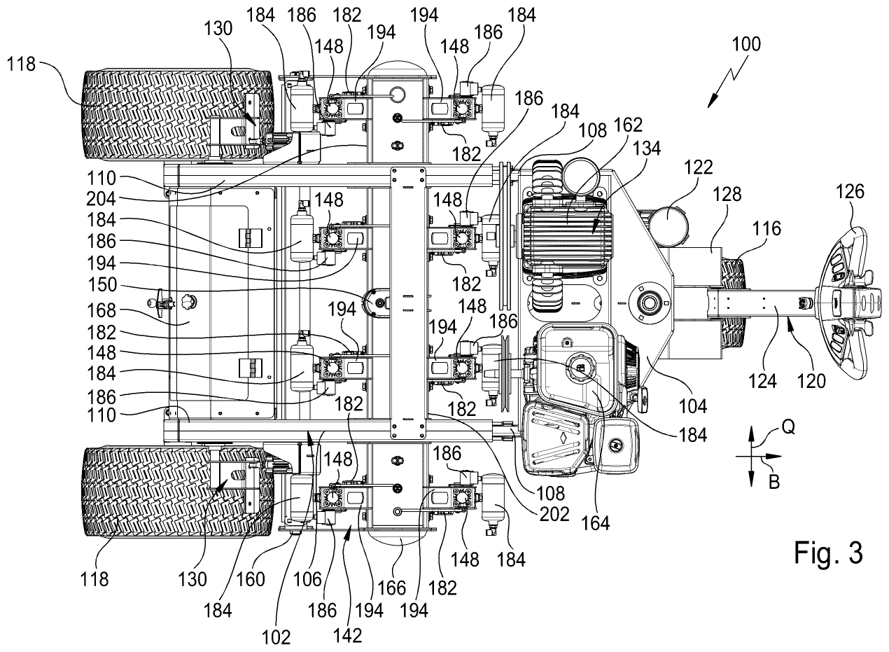

In particular, the respective braking devices 130 are arranged so as to correspond to the rear wheels 118, as can be seen in particular in FIG. 3.

Each rear wheel 118 is associated with a corresponding braking device 130.

Each braking device 130 is engageable with the respective associated rear wheel 118 for decelerating and/or braking the second supporting device portion 106.

The braking device 130 is, inter alia, the subject matter of the above-mentioned non-pre-published patent application entitled “Soil treatment apparatus” by the same applicant with the same filing date as the present patent application. The braking device 130 described in the present patent application is essentially designed and functions as described in the said non-pre-published other patent application.

The return devices 132 are fixed to the first supporting device portion 104 and the second supporting device portion 106, and connect the first supporting device portion 104 and the second supporting device portion 106 to one another.

The first supporting device portion 104 and the second supporting device portion 106 are movable relative to one another and in particular towards one another by means of the return devices 132.

The return device 132 is, inter alia, the subject matter of the above-mentioned, non-pre-published patent application entitled “Soil treatment apparatus” by the same applicant with the same filing date as the present patent application. The return device 132 described in the present patent application is essentially designed and functions as described in the said non-pre-published other patent application.

The soil treatment apparatus 100 further comprises an adjustment device 150 by means of which the holding device 142 can be lifted and lowered relative to the soil.

The adjustment device 150 is, for example, in the form of an electric linear actuator, which can be optionally shortened or extended upon actuation.

The adjustment device 150 serves in particular for finely adjusting a distance between the holding device 142 and the soil.

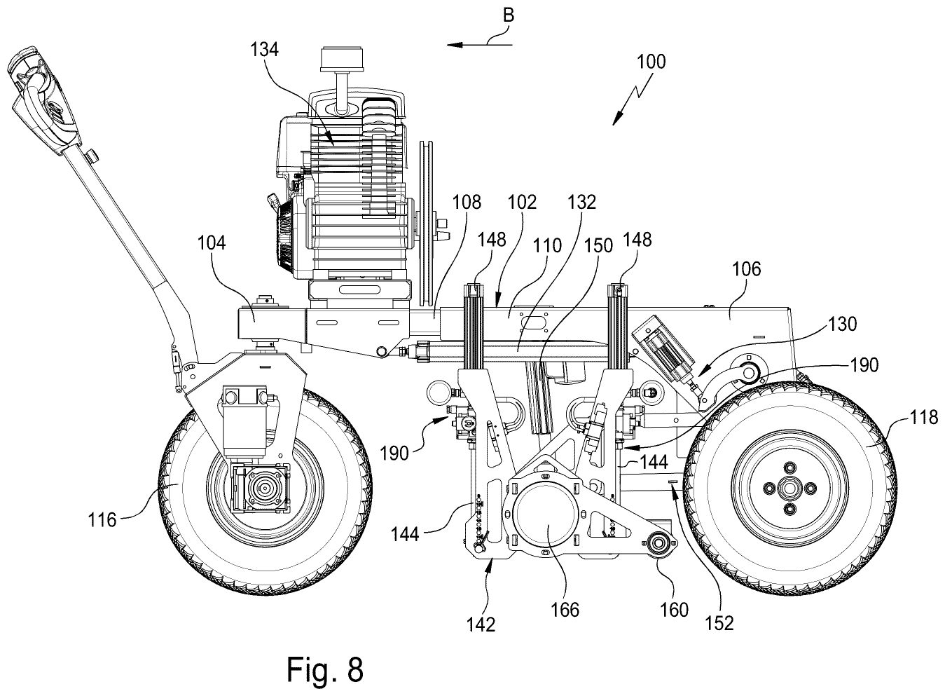

Furthermore, the adjustment device 150 serves to realize a soil treatment position of the holding device 142, in which the holding device 142 is lowered (cf. FIGS. 7 and 9), and a transport position of the holding device 142, in which the holding device 142 is lifted (cf. FIG. 8).

It should be understood that the holding device 142 is preferably situated in the soil treatment position during the intended insertion and withdrawal of the injection elements 144.

The adjustment device 150 is mounted on the inside of and in particular centrally on the second supporting device portion 106 and the holding device 142 with respect to an extent of the second supporting device portion 106 and the holding device 142 oriented transversely and in particular perpendicularly to the processing direction B and interconnects the second supporting device portion 106 and the holding device 142.

By means of a guide apparatus 152, the holding device 142 is movably held on the supporting device 102 and in particular the second supporting device portion 106. Via this guide apparatus 152, the holding device 142 can be lifted and lowered in a guided manner by means of the adjustment device 150.

In particular, the guide apparatus 152 is in the form of a joint apparatus and comprises two first guide members 154 and two second guide members 156.

The guide members 154, 156 are respectively mounted on the holding device 142 and on the supporting device 102 and in particular on the second supporting device portion 106 and are arranged spaced apart from one another and substantially parallel to one another.

The guide device 150 thus forms a parallelogram guide 158 for lifting and lowering.

Furthermore, a roller-shaped support device 160 is movably held on the holding device 142 and in particular on the storage container 166.

The roller-shaped support device 160 is arranged downstream of the injection elements 144 with respect to the processing direction B.

The roller-shaped support device 160 extends transversely and in particular perpendicularly to the processing direction B.

In particular, the roller-shaped support device 160 is held rotatably on the holding device 142 and in particular on the storage container 166 with respect to an axis of rotation oriented transversely and in particular perpendicularly to the processing direction B.

For example, portions of the soil surface can be injected with fluid, in particular compressed air, via the injection elements 144, thereby loosening the soil. The loosened soil portion is then driven over by the trailing support device 160 in order to, for example, smooth out elevations in the soil that can be or have been caused by the fluid injection.

Furthermore, an energy storage device, for example a battery, in particular a rechargeable battery, can be accommodated in said end portion of the second supporting device portion 106, by means of which the adjusting device 150 and/or the travel drive 122 and/or the control device 168 can be supplied with energy.

Referring in particular to FIGS. 7 to 9, the operation of the soil treatment apparatus 100 is again described coherently.

In particular, the operation reflects the clocked movement sequence of the entire soil treatment apparatus 100 and, in particular, the clocked aeration by the injection elements 144.

The soil treatment apparatus 100 is manually steered by a user to a destination via the steering apparatus 120, the soil treatment apparatus 100 being driven by the travel drive 122.

In this case, the holding device 142 is situated in the transport position (cf. FIG. 8).

It is also possible for the user, in particular beforehand, to adjust the holding positions of the injection elements 144 transversely and in particular perpendicularly to the processing direction B via the positioning rails 202, 204 and the respective holding parts 194. In particular, this allows a processing width to be set.

At the destination, the holding device 142 is lowered into the soil treatment position by means of the adjustment device 150 (cf. FIG. 7).

The soil treatment apparatus 100 is then driven and steered by the user over the soil to be treated.

The supporting device 102 is first in the retracted state, or the first relative position is present (cf. FIG. 7).

The rear wheels 118 are now braked by means of the braking devices 130 (cf. FIG. 9), so that the second supporting device portion 106 remains stationary, while the first supporting device portion 104 continues to move.

The supporting device 102 is hereby extended.

The respective injection elements 144 are inserted into the soil individually and/or separately and/or independently of the respective other injection elements 144 by means of the respective lifting elements 148.

In particular, the respective coherent or pre-mountable or pre-mounted assemblies 190 are inserted into the soil individually and/or individually and/or independently of the other injection elements 144 and, in particular, the assemblies 190 by means of the respective lifting elements 148.

Fluid, in particular the pressurized gas or pressurized gas mixture, for example air, is injected from the respective fluid containers 184 through the respective injection elements 144 into the soil for soil loosening by switching the respective outlet valves 186.

At the same time, new fluid flows from the storage container 166 into the respective fluid containers 184.

The respective injection elements 144 are then withdrawn from the soil again using the respective lifting elements 148.

In particular, the respective coherent or pre-mountable or pre-mounted assemblies 190 are withdrawn from the soil individually and/or individually and/or independently of the other injection elements 144 and in particular assemblies 190 by means of the respective lifting elements 148.

The supporting device 102 is now in the pulled-out state, or the second relative position is present (cf. FIG. 9).

The braking devices 130 are released and the second supporting device portion 106 is moved again in the direction of the first supporting device portion 104 by means of the return devices 132.

It should be understood that during these processes the soil treatment apparatus 100 and in particular the first supporting device portion 104 continue to be moved.

When the second supporting device portion 106 and the first supporting device portion 104 are back in their starting position, in particular the first relative position or in the pushed-together state (cf. FIG. 7), the rear wheels 118 are braked again to extend the supporting device 102 and the sequence restarts from the beginning.

In this way, a continuous mode of operation of the soil treatment apparatus 100 can be realized to a certain extent.

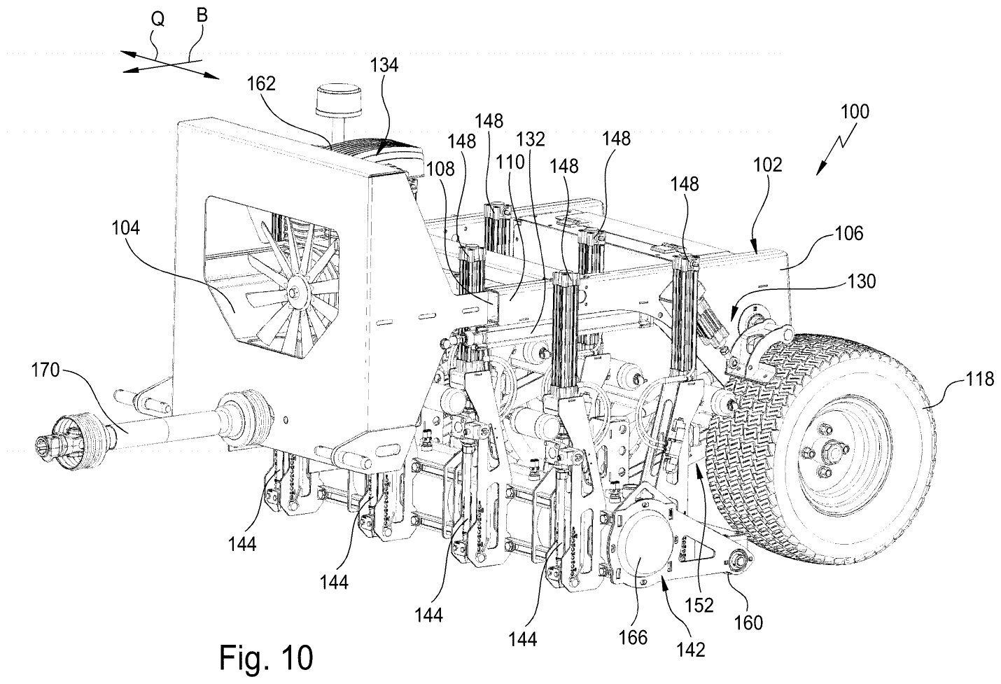

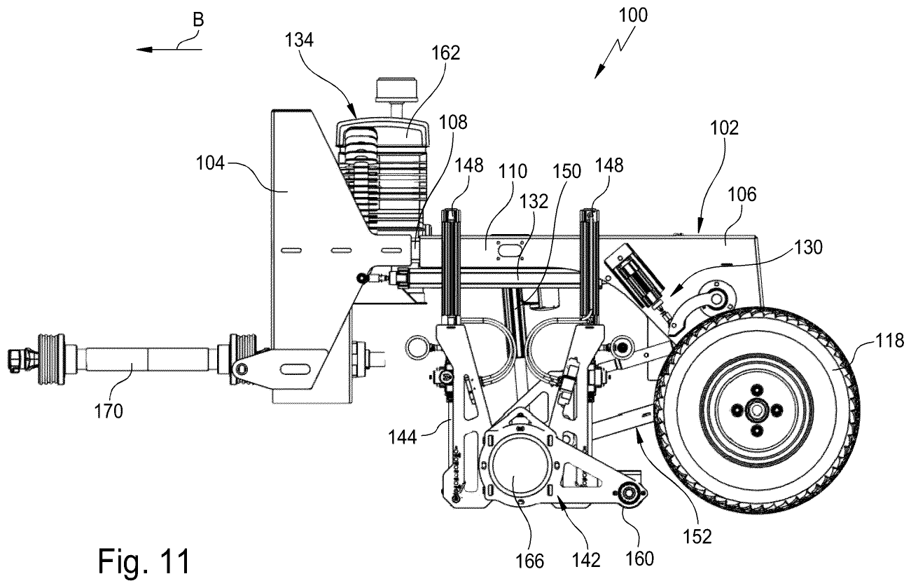

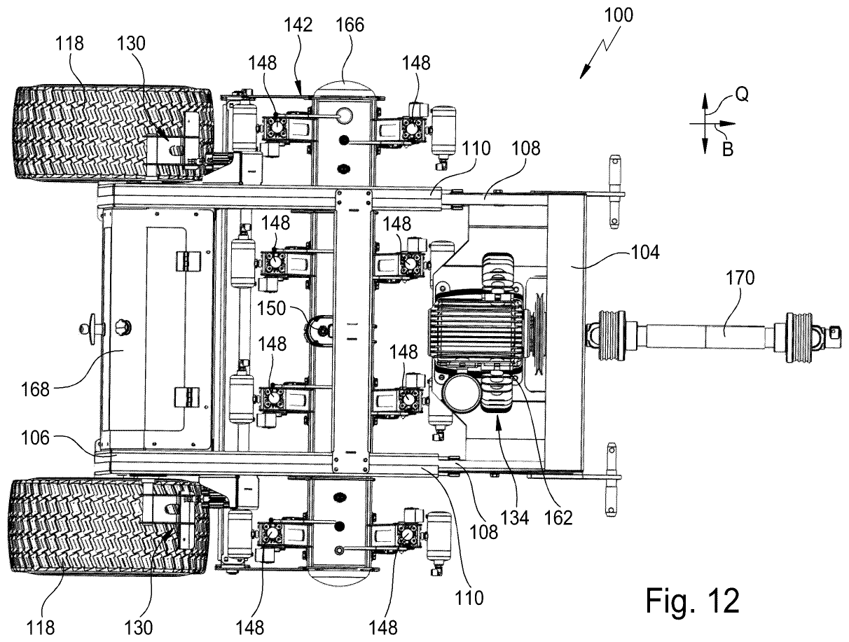

With reference to FIGS. 10 to 12, there is schematically shown a soil treatment apparatus 100 in accordance with a further exemplary embodiment of the present disclosure.

The soil treatment apparatus 100 of FIGS. 10 to 12 is substantially configured and/or designed like the soil treatment apparatus 100 of FIGS. 1 to 9, and therefore the differences in particular are described below.

In particular, the soil treatment apparatus 100 of FIGS. 10 to 12 does not comprise a front wheel 116 or an internal combustion engine 164.

However, the soil treatment apparatus 100 of FIGS. 10 to 12 comprises a coupling device 170.

The coupling device 170 is arranged on and fixed to the first supporting device portion 104 for coupling the soil treatment apparatus 100 to a separate drive system, in particular a towing vehicle, for example a tractor.

Via the coupling device 170, the soil treatment apparatus 100 is configured to be caused to move in the processing direction B, in particular by means of a tensile force able to be exerted by the separate drive system.

In a sense, the soil treatment apparatus 100 is pulled by the separate drive system.

Via the coupling device 170, the soil treatment apparatus 100 can be steered and in particular the processing direction B can be varied.

In a sense, the steering apparatus 120 is realized by the coupling device 170 and can be actuated by the separate drive system by means of a pulling movement able to be generated thereby.

Furthermore, a torque can be transmitted via the coupling device 170 to the soil treatment apparatus 100 and in particular to the air compressor 162 so that it can be operated by the separate drive system.

The mode of operation of the soil treatment apparatus 100 of FIGS. 10 to 12 is carried out in the same way as the mode of operation of the soil treatment apparatus 100 of FIGS. 1 to 9.

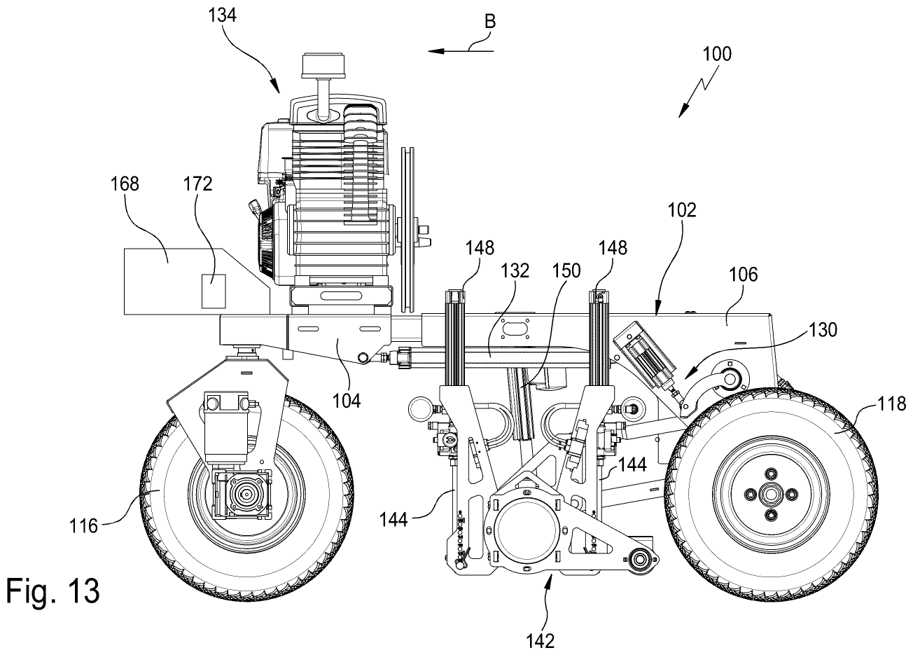

With reference to FIG. 13, there is schematically shown a soil treatment apparatus 100 in accordance with a further exemplary embodiment of the present disclosure.

The soil treatment apparatus 100 of FIG. 13 is substantially configured and/or designed like the soil treatment apparatus 100 of FIGS. 1 to 9, and therefore the differences in particular are described below.

The soil treatment apparatus 100 of FIG. 13 comprises a control unit 168, by means of which the soil treatment apparatus 100 is automatically actuatable and in particular controllable, preferably self-drivingly and/or self-steeringly controllable.

The steering apparatus 120 here comprises a motor 172, in particular an electric motor, via which the processing direction B can be varied and which can be controlled by means of the control unit 168.

The travel drive 122 can also be controlled by means of the control unit 168.

The control unit 168 further comprises a device for navigation, for example comprising a GPS unit, an optical navigation unit (lidar, camera, etc.), and/or a detection unit for detecting a soil contour.

It can be provided that the control unit 168 is or comprises a computer system and/or is or can be connected to a computer system. It can be provided that the computer system can be a server, in particular a cloud-based server.

It can be provided that the control unit 168 is configured to detect and/or provide at least one piece of information about the soil, for example via sensor units connected to the control unit 168, e.g., a camera unit and/or a detection unit.

In particular, the information can be provided to one or more information recipients and an information recipient can be, for example, a user, in particular an end user, e.g., a gardener, groundskeeper, and/or greenkeeper, a display unit, a mobile terminal, software, in particular an app, a server, a computer, a cloud, etc.

As a result, autonomous operation of the soil treatment apparatus 100 can be realized.

Furthermore, the injection elements 144 can thereby be individually selectable and/or groupable, in particular depending on information about the soil. The soil can therefore be ventilated selectively and/or in sections.

The mode of operation of the soil treatment apparatus 100 of FIG. 13 is otherwise carried out in the same way as the mode of operation of the soil treatment apparatus 100 of FIGS. 1 to 9.

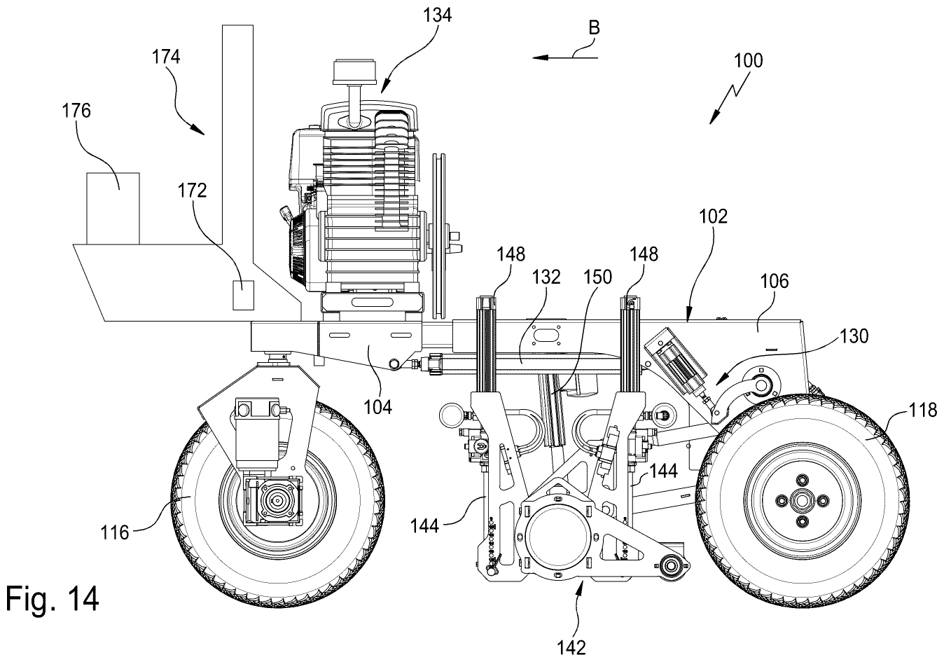

With reference to FIG. 14, there is schematically shown a soil treatment apparatus 100 in accordance with a further exemplary embodiment of the present disclosure.

The soil treatment apparatus 100 of FIG. 14 is substantially configured and/or designed like the soil treatment apparatus 100 of FIGS. 1 to 9, and therefore the differences in particular are described below.

The soil treatment apparatus 100 of FIG. 14 comprises a seat unit 174 for a user to sit on.

An operating unit 176 for operating and controlling, in particular steering, the soil treatment apparatus 100 is provided on the seat unit 174.

For this purpose, the steering apparatus 120 comprises in particular a motor 172, in particular an electric motor, via which the processing direction B can be varied and which can be controlled by means of the control unit 168 in accordance with a user input via the operating unit 176.

In this case, the motor 172 is integrated in the seat unit 174.

Optionally, the control unit 168 can further comprise a device for navigation, for example comprising a GPS unit, an optical navigation unit (lidar, camera, etc.), and/or a detection unit for detecting a soil contour, with the result that autonomous operation of the soil treatment apparatus 100 can additionally be realized. For example, it may be conceivable for the soil treatment apparatus 100 to be driven to its destination by a user, at which destination the soil treatment apparatus 100 autonomously treats the soil, in particular ventilates the soil.

The mode of operation of the soil treatment apparatus 100 of FIG. 14 is otherwise carried out in the same way as the mode of operation of the soil treatment apparatus 100 of FIGS. 1 to 9.

### List of Reference Numerals

100 soil treatment apparatus
102 supporting device
104 first supporting device portion
106 second supporting device portion
108 first guide element
110 second guide element
116 front support element, front wheel
118 rear support element, rear wheel
120 steering apparatus
122 travel drive
124 handle device
126 handle head
128 suspension device
130 braking device
132 return device
134 fluid supply device
142 holding device
144 injection element
146 lifting device
148 lifting element
150 adjusting device
152 guide device
154 first management member
156 second management member
158 parallelogram guide
160 support device
162 air compressor
164 internal combustion engine
166 storage container
168 control device, control unit
170 coupling device
172 motor of steering device
174 seating unit
176 operating unit
178 first control input
180 second control input
182 control valve
184 fluid container
186 exhaust valve
188 fluid connection, hose
190 coherent assembly or pre-mountable or pre-mounted assembly
192 fluid outlet from injection element
194 holding part
196 first holding portion
198 second holding portion
200 middle portion
202 first pair of positioning rails
204 second pair of positioning rails
206 screw connection
208 depth adjustment device
210 stop element
212 counter-stop element
214 recess
216 display device
218 guide passage
220 reset element
B processing direction
Q transverse direction

1. A soil treatment apparatus for loosening soil along a processing direction, the soil treatment apparatus comprising:
a support device;
a holding device movably held on the support device and on which a plurality of injection elements are held;
a lifting device by which the plurality of injection elements are able to be inserted into and withdrawn from the soil; and
a fluid supply device which is fluidically connected, directly or indirectly, to the plurality of injection elements for supplying fluid,
a respective injection element is held on the holding device and is able to be inserted into and withdrawn from the soil individually and/or separately and/or independently of the other injection elements.

2. The soil treatment apparatus according to claim 1, wherein a respective injection element is displaceable under the action of the fluid via the lifting device for respective insertion into the soil and/or respective withdrawal from the soil.

3. The soil treatment apparatus according to claim 1, wherein a respective injection element is held displaceably on the holding device and the lifting device comprises a number of lifting elements corresponding to the plurality of injection elements, by means of which the respective injection elements are able to be inserted into and/or withdrawn from the soil singly and/or individually and/or independently of the respective other injection elements, wherein advantageously the number of lifting elements of the lifting device, are in direct or indirect fluid connection with the fluid supply device.

4. The soil treatment apparatus according to claim 1, wherein a respective injection element for respective insertion into the soil and/or respective withdrawal from the soil is operatively connected to a respective lifting element of the lifting device, wherein a respective lifting element of the lifting device is designed as a fluid-actuated lifting cylinder or comprises such a cylinder, which is advantageously in direct or indirect fluid connection with the fluid supply device.

5. The soil treatment apparatus according to claim 1, wherein the soil treatment apparatus comprises at least one control device for controlling an operation of the soil treatment apparatus, wherein the plurality of injection elements are controllable jointly and in a clocked manner via the at least one control device and are advantageously able to be applied with fluid in a clocked manner.

6. The soil treatment apparatus according to claim 5, wherein the soil treatment apparatus for injecting fluid into the soil via the respective injection elements above their respective reversal points is controllable by the at least one control device, a respective reversal point being defined by an alternation between an insertion into the soil and a withdrawal from the soil of a respective injection element.

7. The soil treatment apparatus according to claim 1, wherein the holding device comprises a number of holding parts corresponding to the plurality of injection elements, which are fastened to the remaining holding device, and by means of which the respective injection elements are held individually on the holding device, wherein each holding part comprises a first holding part portion and a second holding part portion, which are arranged opposite one another and between which the respective injection element is held transversely or perpendicularly to the processing direction.

8. The soil treatment apparatus according to claim 7, wherein the number of holding parts are attached, to the rest of the holding device via a common supporting element.

9. The soil treatment apparatus according to claim 7, wherein the respective holding parts is fixed detachably to the rest of the holding device.

10. The soil treatment apparatus according to claim 7, wherein a respective injection element is guided between the holding part portions of the respective holding part by means of a guide element when the respective injection element is inserted into the soil and/or when the respective injection element is withdrawn from the soil.

11. The soil treatment apparatus according to claim 1, wherein the fluid supply device comprises a number of fluid containers corresponding to the plurality of injection elements, wherein one fluid container is associated with each injection element and is in direct or indirect fluid connection therewith for supplying fluid for the clocked aeration of the soil.

12. The soil treatment apparatus according to claim 11, wherein the fluid container and the associated injection element are held as a coherent assembly on the holding device and the assembly is displaceable during insertion and/or withdrawal of the associated injection element into and out of the soil.

13. The soil treatment apparatus according to claim 1, wherein the fluid supply device comprises a number of outlet valves corresponding to the plurality of injection elements, wherein a respective outlet valve is associated with each injection element and wherein a fluid passage through the respective injection element is switchable by means of the associated outlet valve for injecting, fluid into the soil and/or for clocked aeration of the soil.

14. The soil treatment apparatus according to claim 13, wherein the fluid supply device comprises a number of fluid containers corresponding to the plurality of injection elements, wherein a respective fluid container is rigidly connected to a respective outlet valve and the injection element associated with the fluid container, and the fluid container and the outlet valve are displaceable together with the injection element, the respective outlet valve being arranged fluidically between the respective fluid container and a fluid outlet of the respective injection element.

15. The soil treatment apparatus according to claim 1, wherein the fluid supply device comprises a drivable delivery unit for fluid and wherein, the fluid supply device further comprises at least one storage container for fluid, which is suppliable with fluid for intermediate storage and which is in direct or indirect fluid connection with the plurality of injection elements, via the respective fluid containers.

16. The soil treatment apparatus according to claim 1, wherein the holding device comprises a number of deep-setting devices corresponding to the plurality of injection elements, by means of which an insertion depth of the respective injection elements into the soil is settable singly and/or individually.

17. The soil treatment apparatus according to claim 16, wherein at least one of the following applies:
the insertion depth is settable and/or adjustable incrementally, via the holding device;
on the holding device, a number of display devices corresponding to the plurality of injection elements is provided, wherein the insertion depth of a respective injection element is displayable by means of a respective display device;
the insertion depth is settable and/or adjustable without tools and/or manually.

18. The soil treatment apparatus according to claim 1, wherein the holding device comprises a number of elastically designed reset elements, corresponding to the plurality of injection elements, by means of which a reset force is exertable on the respective injection elements, which is directed away from the soil, wherein advantageously a respective reset element is designed as a spring element or comprises such a spring element.

19. The soil treatment apparatus according to claim 18, wherein each injection element comprises a stop element which, during insertion and/or withdrawal of the injection element into and out of the soil, is operatively connectable to the associated deep-setting device and/or to the associated reset element for limiting the insertion depth of the injection element into the soil and/or for moving the injection element in a direction oriented away from the soil.

20. The soil treatment apparatus according to claim 19, wherein
a respective deep-setting device comprises a counter-stop element which interacts with the stop element of the relevant injection element and which is releasably fixable to the holding device along a direction of displacement of the relevant injection element in order to adjust the depth of insertion, and/or
a respective reset element is arranged between the stop element of the relevant injection element and the associated deep-setting device and/or the counter-stop element of the associated deep-setting device.

21. The soil treatment apparatus according to claim 1, wherein each injection element is held individually on the holding device and a holding position of each injection element on the holding device is adjustable, transversely or perpendicularly to the processing direction, wherein the holding device comprises at least one positioning rail, by means of which the holding position of each injection element is fixable on the holding device with respect to the direction transverse or perpendicular to the processing direction.

22. The soil treatment apparatus according to claim 1, wherein the supporting device comprises at least a first supporting device portion and a second supporting device portion, wherein the soil treatment apparatus is able to be caused to move in the processing direction via the first supporting device portion and the holding device is held on the second supporting device portion, wherein the first supporting device portion and the second supporting device portion are arranged one behind the other along the processing direction and are connected to one another so as to be displaceable, wherein, the plurality of injection elements are able to be inserted into and withdrawn from the soil by means of the lifting device during a relative displacement of the first supporting device portion and the second supporting device portion relative to one another or when the soil treatment apparatus is not caused to move.

23. The soil treatment apparatus according to claim 1, wherein:
the soil treatment apparatus has at least one travel drive which is arranged on and/or in the supporting device and by means of which the soil treatment apparatus is able to be caused to move in the processing direction, and/or
the soil treatment apparatus has at least one coupling device which is arranged on and/or in the supporting device for coupling the soil treatment apparatus to a separate drive system, and by means of which the soil treatment apparatus is able to be caused to move in the processing direction, by means of a tractive force which is exertable by the separate drive system.

24. The soil treatment apparatus according to claim 1, further comprising a steering apparatus via which the processing direction is variable, wherein the steering apparatus is manually actuatable by a user and/or by a separate drive system by a pulling movement able to be generated thereby and/or actuatable and controllable automatically by a control unit associated with the soil treatment apparatus or comprised by the soil treatment apparatus.

25. The soil treatment apparatus according to claim 24, wherein the soil treatment apparatus is self-drivingly and/or self-steeringly controllable.
